(19) United States
(12) Patent Application Publication
(10) Pub. No.: US 2016/0204702 A1
(43) Pub. Date: Jul. 14, 2016

(54) Low Output Ripple Adaptive Switching Voltage Regulator

(71) Applicant: Broadcom Corporation, Irvine, CA (US)

(72) Inventors: Aravind Kumar PADYANA, Costa Mesa, CA (US); Iuri Mehr, Irvine, CA (US); Jay Ackerman, Fort Collins, CO (US); Mark Rutherford, Wellington, CO (US); Daniel Melendy, Fort Collins, CO (US); Eric Martin Hayes, Fort Collins, CO (US)

(73) Assignee: Broadcom Corporation, Irvine, CA (US)

(21) Appl. No.: 14/640,893

(22) Filed: Mar. 6, 2015

Related U.S. Application Data
(60) Provisional application No. 62/101,208, filed on Jan. 8, 2015.

(51) Int. Cl. H02M 3/158

(52) U.S. Cl. CPC H02M 3/158

(57) ABSTRACT

A hysteretic switching regulator with low output ripple voltage is disclosed herein. A detector and controller is specifically used to adjust a parameter of the hysteretic switching regulator to compensate for changes in one or more of input voltage and desired output voltage to maintain the output ripple voltage within some desired range.

### CROSS REFERENCE TO RELATED APPLICATIONS

This application claims the benefit of U.S. Provisional Patent Application No. 62/101,208, filed Jan. 8, 2015, which is incorporated by reference herein.

### TECHNICAL FIELD

This application relates generally to switching voltage regulators, including hysteretic switching voltage regulators.

### BACKGROUND

Switching regulators are designed to provide a regulated output voltage from an unregulated input voltage. They are frequently implemented in battery powered electronic devices to regulate the battery output voltage which, when charged or discharged, can be greater than, less than, or substantially the same as the desired output voltage.

In general, a switching regulator works by periodically transferring small amounts of energy from the input voltage source to the output. This is accomplished with the help of one or more power switches and a controller that regulates the rate at which energy is transferred to the output. FIG. 1 illustrates an exemplary buck switching regulator 100 that works in this general manner to step-down an input voltage V_{IN} to provide a regulated output voltage V_{OUT}. Buck switching regulator 100 includes a power switch module 110, a low-pass filter 120, a sensing network 130, and a duty cycle controller 140.

In the step-down regulator of FIG. 1, the basic circuit operation is to close switch 150 for a time ton and then open it for a time toff. The total on and off time of switch 150 is referred to as the switching period T. Switch 160 is controlled in the opposite manner as switch 150 and is open while switch 150 is closed, and closed while switch 150 is open. Thus, ignoring any voltage drop across switches 150 and 160, the voltage at the input to filter 120 is V_{IN} during the time ton and ground or zero during the time toff

With switches 150 and 160 turning on and off, high-frequency voltage pulses are applied at the input of low pass filter 120 and an averaged DC level comes out as V_{OUT}. By altering the ratio of the on time of switch 150 to the switching period, the averaged DC level of V_{OUT} can be changed.

Duty cycle controller 140 is configured to adjust the ratio of the on time of switch 150 to the switching period in accordance with a feedback signal provided by sensing network 130. The feedback signal is related to the current value of V_{OUT}. The ratio of the on time of switch 150 to the switching period is altered as needed by duty cycle controller 140 to regulate the output voltage V_{OUT} at a desired value.

There are several different topologies for implementing duty cycle controller 140. Depending on the topology, the ratio of the on time of switch 150 to the switching period (i.e., the duty cycle) can be altered in a number of ways. The two most common approaches are pulse-width modulation (PWM) and variable frequency. In PWM based control topologies, the switching period is generally fixed and the on time of switch 150 is varied. Conversely, in variable frequency control topologies, the switching period is not fixed and changes as the on time and/or off time of switch 150 is varied.

Hysteretic switching regulators are one type of switching regulator based on a variable frequency control topology. These switching regulators have several advantages over switching regulators based on PWM control topologies. For example, unlike switching regulators based on PWM control topologies, hysteretic switching regulators do not require an oscillator and therefore are generally simpler to implement.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 illustrates a buck switching regulator.

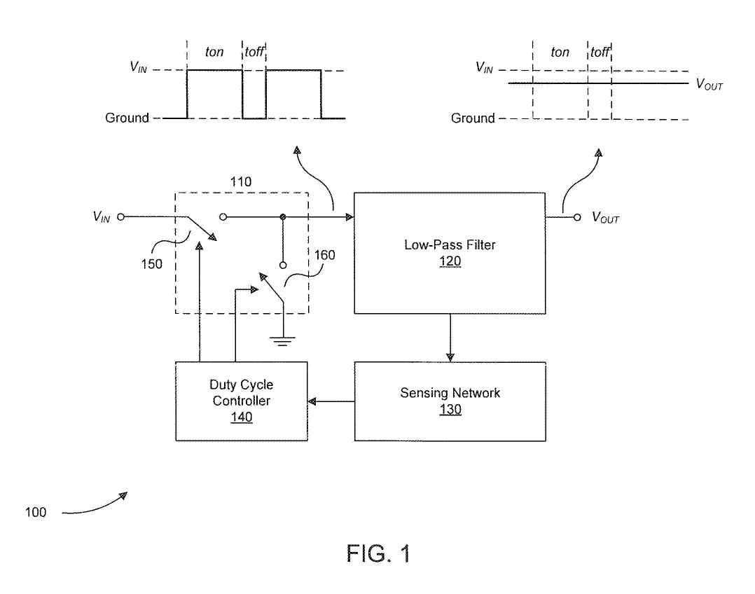

FIG. 2 illustrates a hysteretic switching regulator with a high output ripple voltage.

FIG. 3 illustrates an exemplary plot of switching frequency versus output voltage for the hysteretic switching regulator of FIG. 2.

FIG. 4 illustrates a hysteretic switching regulator with low output ripple voltage according to embodiments of the present disclosure.

FIG. 5 illustrates a method for maintaining output ripple voltage in a hysteretic switching regulator within some desired range according to embodiments of the present disclosure.

FIG. 6 illustrates another hysteretic switching regulator with low output ripple voltage according to embodiments of the present disclosure.

FIG. 7 illustrates another method for maintaining output ripple voltage in a hysteretic switching regulator within some desired range according to embodiments of the present disclosure.

The present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of this discussion, the term “module” shall be understood to include software, firmware, or hardware (such as one or more circuits, microchips, processors, and/or devices), or any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

### 1. HYSTERETIC SWITCHING REGULATOR WITH HIGH OUTPUT RIPPLE VOLTAGE

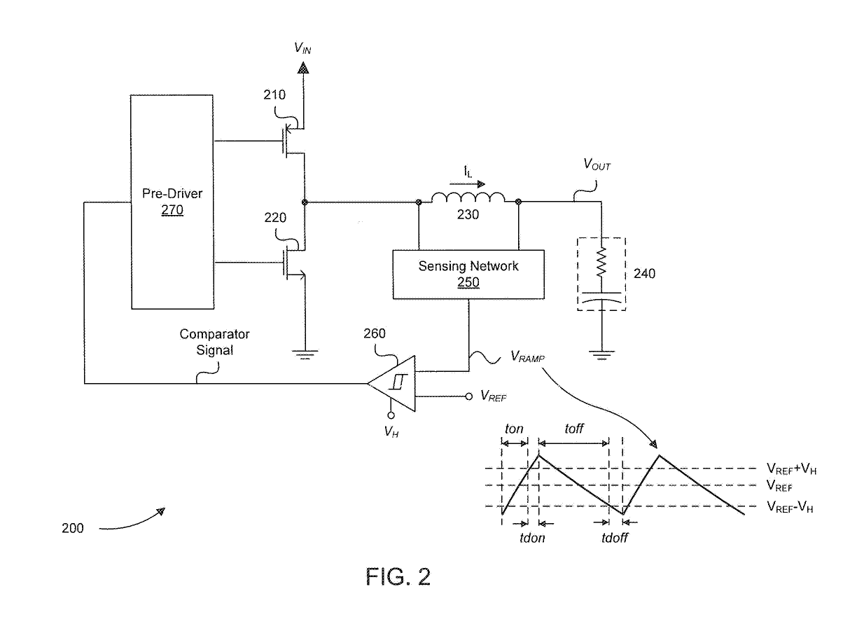

FIG. 2 illustrates a hysteretic switching regulator 200 that is configured to step-down an unregulated input voltage V_{IN} to provide a regulated output voltage V_{OUT}. Hysteretic switching regulator 200 includes a first power switch 210, a second power switch 220, an inductor 230, a capacitor 240 (with equivalent series resistance (ESR) shown), a sensing network 250, a hysteretic comparator 260, and a pre-driver module 270. Power switches 210 and 220 (e.g., transistors) form a power switch module, and inductor 230 and capacitor 240 form a low pass filter.

At a high-level, pre-driver module 270 receives a comparator signal from hysteretic comparator 260 and drives power switches 210 and 220 with sufficient strength to turn them on and off as directed by the comparator signal. In general, the comparator signal controls the configuration and timing of power switches 210 and 220 to regulate the flow of power from the source (e.g., a battery) providing the unregulated input voltage V_{IN} to the low pass filter formed by inductor 230 and capacitor 240. The low pass filter converts the switched voltage pulses, produced by the switching action of switches 210 and 220, into a steady current and regulated output voltage V_{OUT}.

To maintain V_{OUT} at a desired value, sensing network 250 integrates the voltage across inductor 230 and extracts the AC content of the voltage across inductor 230, which it then superimposes on top of V_{OUT} (or some fraction of V_{OUT}) to form a feedback signal V_{RAMP}. The integrated voltage value is representative of the current I_{L} flowing through inductor 230. An example waveform of V_{RAMP} is illustrated in the lower right hand corner of FIG. 2.

Hysteretic comparator 260 compares V_{RAMP} to a reference voltage V_{REF} that is set equal to the desired value of V_{OUT} (or some fraction of the desired value of V_{OUT}). When V_{RAMP} becomes less than V_{REF}˜V_{H}, where V_{H} is the hysteresis of hysteretic comparator 260, the comparator signal transitions to a logical high level, signaling to pre-driver module 270 to turn on, switch 210 and turn off switch 220. Switch 210 remains on and switch 220 remains off for a period of time ton sufficient to raise V_{RAMP} up to V_{REF}+V_{H} plus some propagation delay tdon associated with components in the feedback loop (e.g., hysteretic comparator 260 and pre-driver module 270). During the time period (ton+tdon) the unregulated input voltage V_{IN} is coupled to one end of inductor 230 (ignoring any voltage drop across switch 210) and the output voltage V_{OUT} is coupled to the other end. Thus, the voltage across inductor 230 is equal to V_{IN}−V_{OUT} and both the current I_{L} flowing through inductor 230 and V_{RAMP} increase (substantially) linearly at a rate proportional to (V_{IN}−V_{OUT})/L, where L is the inductance of inductor 230. The following equation describes the change in I_{L} during the time switch 210 is on and switch 220 is off:

$$\frac{{V}_{IN} - {V}_{OUT}}{L} * ( ton + tdon ) = Δ {I}_{L} \qquad ( 1 )$$

Because of the propagation delay tdon, inductor 230 remains coupled to V_{IN} through switch 210 even after V_{RAMP} rises above V_{REF}+V_{II} for the period of time defined by tdon.

Once V_{RAMP} becomes greater than V_{REF}+V_{H}, the comparator signal transitions to a logical low level, signaling to pre-driver module 270 to turn off switch 210 and turn on switch 220. Switch 210 is turned off and switch 220 is turned on for a period of time toff until V_{RAMP} again falls below V_{REP}˜V_{H} plus some propagation delay (doff associated with components in the feedback loop (e.g., hysteretic comparator 260 and pre-driver module 270). During the time period (toff+tdoff), inductor 230 is coupled to ground (ignoring any voltage drop across switch 220) at one end and. V_{OUT} at the other. Thus, the voltage across inductor 230 is equal to −V_{OUT}, and both the current I_{L} flowing through inductor 230 and V_{RAMP} decrease (substantially) linearly at a rate proportional to −V_{OUT}/L. The following equation describes the change in I_{L} while switch 210 is off and switch 220 is on:

$$\frac{- {V}_{OUT}}{L} * ( toff + tdoff ) = Δ {I}_{L} \qquad ( 2 )$$

Because of the propagation delay tdoff, inductor 230 remains coupled to ground through switch 220 even after V_{RAMP} falls below V_{REF}−V_{H} for the period of time defined by tdoff.

The change in I_{L} during the time (ton+tadon) is equal and opposite to the change in I_{L} during the time (toff+tdofff), and equations (1) and (2) can be set equal. By setting equations (1) and (2) equal, a basic relationship between V_{IN} and V_{OUT} can be derived. This basic relationship is given by the following equation:

$${V}_{OUT} = {V}_{IN} \frac{( ton + tdon )}{( ton + tdon ) + ( toff + tdoff )} = {V}_{IN} * D \qquad ( 3 )$$

where D is the duty cycle (i.e., the ratio of the on time of switch 210 to the switching period). As can be seen from equation (3), V_{OUT} is generally dependent and determined by V_{IN} and the duty cycle D, and is generally not dependent on the switching frequency given by 1/(ton+tdon+tdoff).

Although the output voltage V_{OUT} is generally not dependent on the switching frequency of switches 210 and 220, the rate at which switches 210 and 220 turn on and off is still an important design consideration. In particular, it can be shown that the switching frequency is an important design consideration because it is inversely proportional to the change in inductor current AA (also referred to as the inductor ripple current) given by equations (1) and (2) above, which further impacts the extent of ripple voltage on the output voltage V_{OUT}.

Specifically, assuming the capacitance of capacitor 240 is sufficiently large, the ripple voltage on the output voltage V_{OUT} is approximately given by ΔI_{L}*ESR, where ESR is the equivalent series resistance of capacitor 240. Ripple voltage is an unwanted, periodic variation of the output voltage V_{OUT}. Minimizing or maintaining ripple voltage within some pre-defined range is often important for noise sensitive devices (e.g., high resolution analog-to-digital converters and high-speed integrated circuits) powered by the output voltage V_{OUT}.

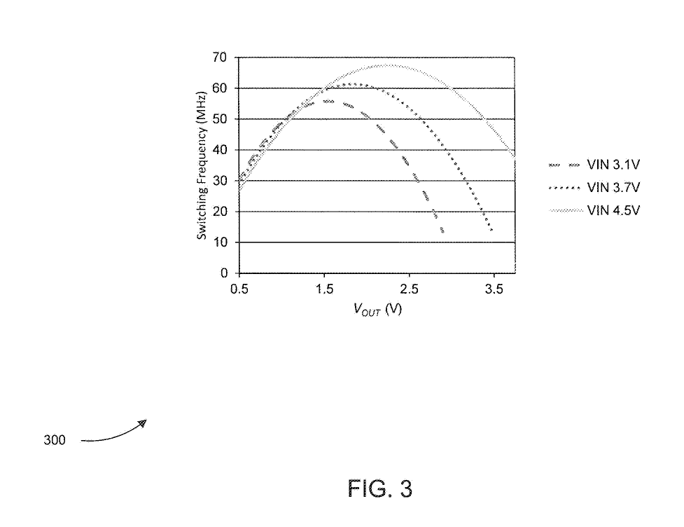

The switching frequency in hysteretic switching regulators is generally not constant and can vary widely during operation. For example, the switching frequency generally depends on the value of V_{IN}, V_{REF}, and V_{OUT} (which is set by V_{REF}). FIG. 3 illustrates an exemplary plot 300 of the switching frequency of hysteretic switching regulator 200 versus output voltage V_{OUT} for three different input voltages I_{IN}: 3.1 V, 3.7 V, and 4.5 V. Plot 300 is shown under the assumption of a constant ripple voltage on the output voltage V_{OUT}. As can be seen from plot 300, the switching frequency varies widely over both changes in the output voltage V_{OUT} and the input voltage V_{IN}. More specifically, the switching frequency decreases as the ratio of the input voltage V_{IN} to the output voltage V_{OUT} gets further away from an approximate value of two where the switching frequency is at a maximum. This potential wide variation in switching frequency, coupled with propagation delays tdon and tdoff that limit the maximum switch frequency achievable, can make it difficult to maintain the ripple voltage of hysteretic switching regulator 200 within a pre-defined range.

As will be explained further below, embodiments of the present disclosure are directed to an apparatus and method for changing a circuit parameter k that controls the slope (or ramp rate) of the feedback signal V_{RAMP}. The circuit parameter k is specifically controlled to adjust the switching frequency of hysteretic switching regulator 200 to maintain the ripple voltage of the output voltage V_{OUT} within a pre-defined range over different input voltages V_{IN} and desired output voltages V_{OUT}. For example, by speeding up the switching frequency, the change in inductor current AA during steady state conditions is decreased and, thereby, the ripple voltage (given approximately by AA*ESR) is also decreased.

It should be noted that, at higher switching frequencies, hysteretic switching regulator 200 is generally less efficient and consumes more power. Therefore, in at least one embodiment, the apparatus and method of the present disclosure changes the parameter of the integrator to ensure that the switching frequency of hysteretic switching regulator 200 is sufficiently high to meet, but not necessarily exceed, the output ripple voltage requirements.

### 2. HYSTERETIC SWITCHING REGULATOR WITH LOW OUTPUT RIPPLE VOLTAGE

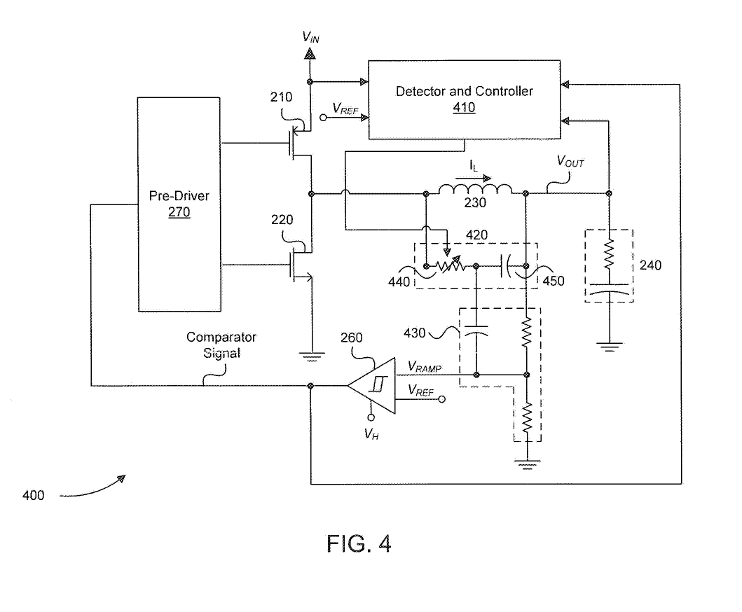

FIG. 4. Illustrates a hysteretic switching regulator 400 with low output ripple voltage over a wide range of input voltages V_{IN} and output voltages V_{OUT} according to embodiments of the present disclosure. As illustrated in FIG. 4, hysteretic switching regulator 400 includes a substantially similar structure as hysteretic switching regulator 200 illustrated in FIG. 2. However, hysteretic switching regulator 400 further includes a detector and controller 410 and an exemplary embodiment of sensing network 250 formed by an integrator 420 and a scaling network 430. The capacitor in scaling network 430 is used as a DC-blocking capacitor to superimpose the AC content of the integrated voltage from integrator 420 on to the steady state output DC voltage from the resistor divider formed by the two resistors in scaling network 430.

In operation, hysteretic switching regulator 400 works in the same general manner as described above in regard to hysteretic switching regulator 200 to maintain output voltage V_{OUT} at a desired voltage V_{REF} (or some multiple of V_{REF}). However, during the course of operation, detector and controller 410 is configured to determine a desired switching frequency range for hysteretic switching regulator 400, based on the input voltage V_{IN} and/or the voltage V_{REF}. Detector and controller 410 specifically determines the desired switching frequency range to maintain the ripple voltage of output voltage V_{OUT} within some desired range.

As noted above, at higher switching frequencies the ripple voltage of output voltage T_{OUT} is reduced. However, hysteretic switching regulators are generally less efficient and consume more power at higher switching frequencies. Therefore, in at least one embodiment, detector and controller 410 is configured to determine the lower and upper bounds of the desired switching frequency range such that the switching frequency of hysteretic switching regulator 400 is sufficiently high to meet output ripple voltage requirements. In one embodiment, detector and controller 410 utilizes a look-up table to determine the desired switching frequency range for a given input voltage V_{IN} and/or voltage V_{REF}.

After determining the desired switching frequency range, detector and controller 410 is configured to determine whether the current switching frequency for hysteretic switching regulator 400 is within the desired switching frequency range. In one embodiment, detector and controller 410 can monitor the comparator signal output by hysteretic comparator 260 to determine the current switching frequency.

If detector and controller 410 determines that the current switching frequency of hysteretic switching regulator 400 is above and/or below the bounds of the desired switching frequency range, detector and controller 410 can adjust a circuit parameter k of hysteretic switching regulator 400 that controls the slope (or ramp rate) of the feedback signal V_{RAMP}. The circuit parameter k can be, for example, a parameter of integrator 420 that affects the rate at which the feedback signal V_{RAMP} changes for a given voltage across inductor 230. For larger slopes, the output of hysteretic comparator 260 will flip more quickly and, as a result, the switching frequency will increase. For smaller slopes, the output of hysteretic comparator 260 will flip less quickly and, as a result, the switching frequency will decrease.

If detector and controller 410 specifically determines that the current switching frequency of hysteretic switching regulator 400 is below the bounds of the desired switching frequency range, detector and controller 410 can adjust the circuit parameter k of hysteretic switching regulator 400 to increase the slope of the feedback signal V_{RAMP} and, thereby, increase the frequency of hysteretic switching regulator 400. Conversely, if detector and controller 410 specifically determines that the current switching frequency of hysteretic switching regulator 400 is above the bounds of the desired switching frequency range, detector and controller 410 can adjust the circuit parameter k of hysteretic switching regulator 400 to decrease the slope of the feedback signal V_{RAMP} and, thereby, decrease the frequency of hysteretic switching regulator 400.

In one embodiment, and as illustrated in FIG. 4, integrator 420 includes a variable resistor 440 and a capacitor 450. The series combination of variable resistor 440 and capacitor 450 across inductor 230 forms a low pass filter that approximates an integration function responsible for “integrating” the voltage across inductor 230. In the specific embodiment of integrator 420 illustrated in FIG. 4, the circuit parameter k of hysteretic switching regulator 400 corresponds to the resistance parameter of resistor 440 multiplied by the capacitance parameter of capacitor 450 and is related to the rate at which the feedback signal V_{RAMP} changes for a given voltage across inductor 230. In general, the resistance parameter and/or the capacitance parameter of integrator 420 can be adjusted by detector and controller 410 during operation to maintain the switching frequency within the desired switching frequency range. In practice, however, it is often easier to adjust the resistance parameter of resistor 440. /

It should be noted that integrator 420 and scaling network 430 represent only one possible implementation of sensing network 250 shown in FIG. 2. Other implementations of sensing network 250 are possible without departing from the scope and spirit of the present disclosure as would be appreciated by one of ordinary skill in the art.

It should be similarly noted that the series combination of resistor 440 and capacitor 450 represents only one possible implementation of integrator 420. Other implementations of integrator 420 are possible without departing from the scope and spirit of the present disclosure as would be appreciated by one of ordinary skill in the art

In another embodiment, detector and controller 410, in addition to or as an alternative to detecting switching frequency, can directly detect the amount of ripple voltage on output voltage V_{OUT} and adjust the circuit parameter k of hysteretic switching regulator 400 on maintain the ripple voltage on output voltage V_{OUT} within some desired range. For example, if the detected amount of ripple voltage on output voltage V_{OUT} is above the bounds of the desired ripple voltage range, the circuit parameter k of hysteretic switching regulator 400 can be adjusted as described above to increase the switching frequency of hysteretic switching regulator 400 and, thereby, decrease the ripple voltage on output voltage V_{OUT}.

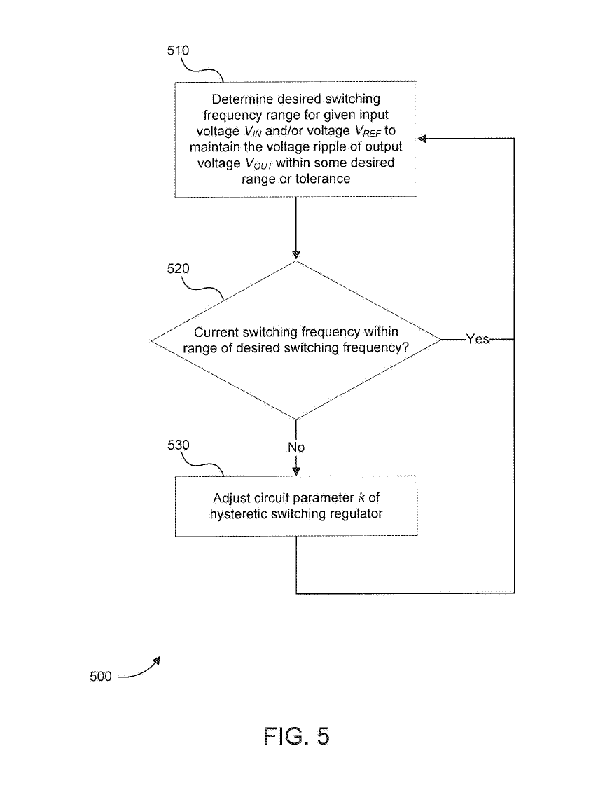

It should be noted that detector and controller 410 can be implemented within any reasonable hysteretic switching regulator topology without departing from the scope and spirit of the present disclosure as would be appreciated by one of ordinary skill in the art. For example, detector and controller 410 can be implemented within a boost or buck-boost hysteretic switching regulator to adjust a circuit parameter k of the switching hysteretic switching regulator to maintain the switching frequency within a desired switching frequency range and, thereby, the ripple voltage of output voltage V_{OUT} within some desired range. In addition, detector and controller 410 can be implemented within hysteretic switching regulators with power switches that have been implemented using JFET or BJT devices, or even a diode, rather than the FET devices as illustrated in FIG. 4. Even further, detector and controller 410 can be implemented within hysteretic switching regulators that utilize one or more additional components, such as a non-overlap generation circuit to prevent switches 210 and 220 from being on at the same time and an over current detection circuit. FIG. 5 illustrates an exemplary method 500 for maintaining output ripple voltage in a hysteretic switching regulator within some desired range according to embodiments of the present disclosure. Method 500 is described below with reference to hysteretic switching regulator 400 in FIG. 4. It will be appreciated by one of ordinary skill in the art that method 500 can be applied to other switching regulators without departing from the scope and spirit of the present disclosure.

Method 500 starts at step 510. At step 510, a desired switching frequency range for a given input voltage V_{IN} and/or voltage V_{REF}, determined by detector and controller 410 to maintain the ripple voltage of output voltage V_{OUT} within some desired range. After step 510, method 500 transitions to step 520.

At step 520, the current switching frequency of the hysteretic switching regulator is compared to the desired switching frequency range. If the current switching frequency of the hysteretic switching regulator is within the desired switching frequency range, method 500 proceeds back to step 510 and method 500 is repeated. If, on the other hand, the current switching frequency of the hysteretic switching regulator is not within the desired switching frequency range, method 500 proceeds to step 530.

At step 530, a circuit parameter k of hysteretic switching regulator 400 that controls the slope (or ramp rate) of the feedback signal V_{RAMP} is adjusted to maintain the switching frequency within the desired switching frequency range. In one embodiment, the circuit parameter k corresponds to the resistance parameter of resistor 440 multiplied by the capacitance parameter of capacitor 450 and is related to the rate at which the feedback signal V_{RAMP} changes for a given voltage across inductor 230. In general, the resistance parameter and/or the capacitance parameter of integrator 420 can be adjusted by detector and controller 410 during operation to maintain the switching frequency within the desired switching frequency range. After step 530 completes, method 500 transitions back to step 510 and method 500 is repeated. In one embodiment, method 500 is repeated after a set delay or after a pre-determined period of time has expired.

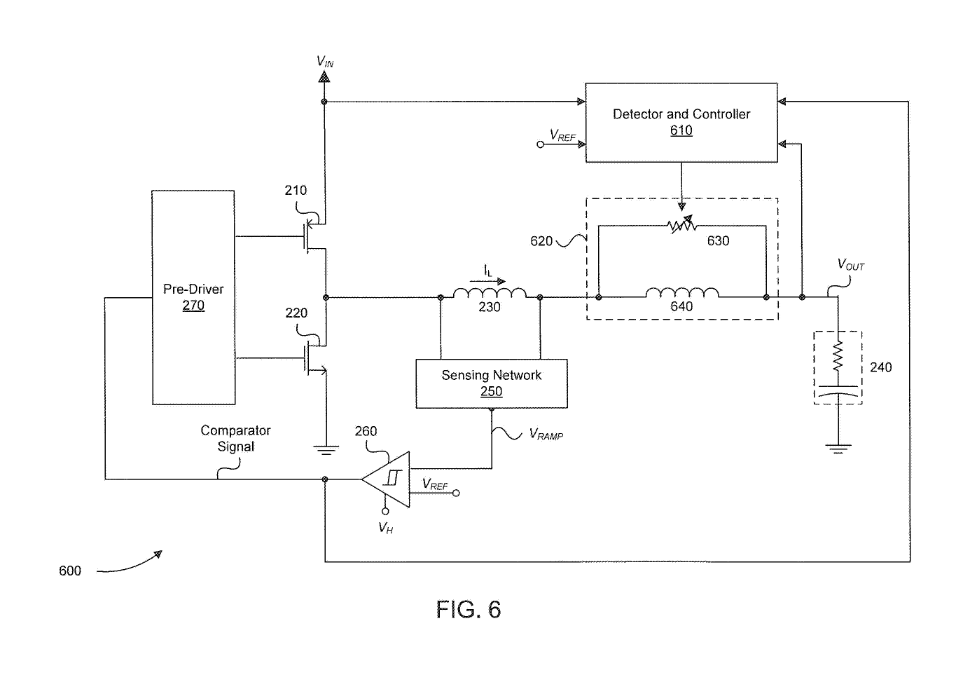

Referring now to FIG. 6, another hysteretic switching regulator 600 with low output ripple voltage over a wide range of input voltages V_{IN} and output voltages V_{OUT} is illustrated according to embodiments of the present disclosure. Hysteretic switching regulator 600 includes a substantially similar structure as hysteretic switching regulator 200 illustrated in FIG. 2. However, hysteretic switching regulator 600 further includes a detector and controller 610 and an adaptive network 620 formed by a variable resistor 630, and an inductor 640. The circuit parameter k of hysteretic switching regulator 600 corresponds to the resistance parameter of variable resistor 630. Adaptive network 620 is coupled in series with load capacitor 240.

In operation, hysteretic switching regulator 600 works in the same general manner as described above in regard to hysteretic switching regulator 200 to maintain output voltage V_{OUT} at a desired voltage V_{REF} (or some multiple of V_{REF}). However, during the course of operation, detector and controller 610 is configured to determine a desired switching frequency range and/or output ripple voltage for hysteretic switching regulator 600, based on the input voltage V_{IN} and/or the voltage V_{REF}. Detector and controller 610 specifically determines the desired switching frequency range to maintain the ripple voltage of output voltage V_{OUT} within some desired range.

As noted above, at higher switching frequencies the ripple voltage of output voltage V_{OUT} is reduced. However, hysteretic switching regulators are generally less efficient and consume more power at higher switching frequencies. Therefore, in at least one embodiment, detector and controller 610 is configured to determine the lower and upper bounds of the desired switching frequency range such that the switching frequency of hysteretic switching regulator 600 is sufficiently high to meet output ripple voltage requirements. In one embodiment, detector and controller 610 utilizes a look-up table to determine the desired switching frequency range for a given input voltage V_{IN} and/or voltage V _{REF}. /

After determining the desired switching frequency range, detector and controller 610 is configured to determine whether the current switching frequency for hysteretic switching regulator 600 is within the desired switching frequency range. In one embodiment, detector and controller 610 can monitor the comparator signal output by hysteretic comparator 260 to determine the current switching frequency.

If detector and controller 610 determines that the current switching frequency of hysteretic switching regulator 600 is below the bounds of the desired switching frequency range, detector and controller 610 can control adaptive network 620 through variable resistor 630. Detector and controller 610 can subsequently adjust the resistance of variable resistor 630 until the switching frequency of hysteretic switching regulator 600 is brought within the desired switching frequency range.

The AC component of the inductor current I_{L} flowing through inductor 230 is sensed by variable resistor 630, thereby producing a voltage across variable resistor 630. This voltage adds in phase with the integrator voltage produced by sensing network 250 to generate the feedback signal V_{RAMP}, thereby increasing the slope (or ramp rate) of the feedback signal V_{RAMP}. For larger slopes, the output of hysteretic comparator 260 will flip more quickly and, as a result, the switching frequency will increase. The resistance of variable resistor 630 can be subsequently adjusted by detector and controller 610 to further increase or decrease the resulting voltage produced across variable resistor 630 and, thereby, increase or decrease the switching frequency of hysteretic switching regulator 600.

In one embodiment, the resistance Rₚ of variable resistor 630 and the inductance Lₚ of inductor 640 are chosen such that, at the maximum switch frequency f_{sw,max} of hysteretic switching regulator 600, Rₚ<(2π*f_{sw,max}*Lp) and Lₚ is much less than the inductance of inductor 640 (e.g., by at least an order of magnitude). In another embodiment, the corner frequency of the 2^{nd}-order low pass filter formed by Lₚ and the capacitance of capacitor 240 is chosen to be less than the maximum switching frequency f_{sw,max} so as to provide further attenuation for the voltage ripple on output voltage V_{OUT}.

In another embodiment, detector and controller 610, in addition to or as an alternative to detecting switching frequency, can directly detect the amount of ripple voltage on output voltage V_{OUT} and adjust variable resistor 630 to maintain the ripple voltage on output voltage V_{OUT} within some desired range. For example, if the detected amount of ripple voltage on output voltage V_{OUT} is above the bounds of the desired ripple voltage range, the resistance of variable resistor 630 can be adjusted as described above to increase the switching frequency of hysteretic switching regulator 400 and, thereby, decrease the ripple voltage on output voltage V_{OUT}.

It should be noted that detector and controller 610 can be implemented within any reasonable hysteretic switching regulator topology, operating in either continuous conduction mode or discontinuous conduction mode, without departing from the scope and spirit of the present disclosure as would be appreciated by one of ordinary skill in the art. For example, detector and controller 610 can be implemented within a boost or buck-boost hysteretic switching regulator. In addition, detector and controller 610 can be implemented within hysteretic switching regulators with power switches that have been implemented using JFET or BJT devices, or even a diode, rather than the FET devices as illustrated in FIG. 6. Even further, detector and controller 610 can be implemented within hysteretic switching regulators that utilize one or more additional components, such as a non-overlap generation circuit to prevent switches 210 and 220 from being on at the same time and an over current detection circuit.

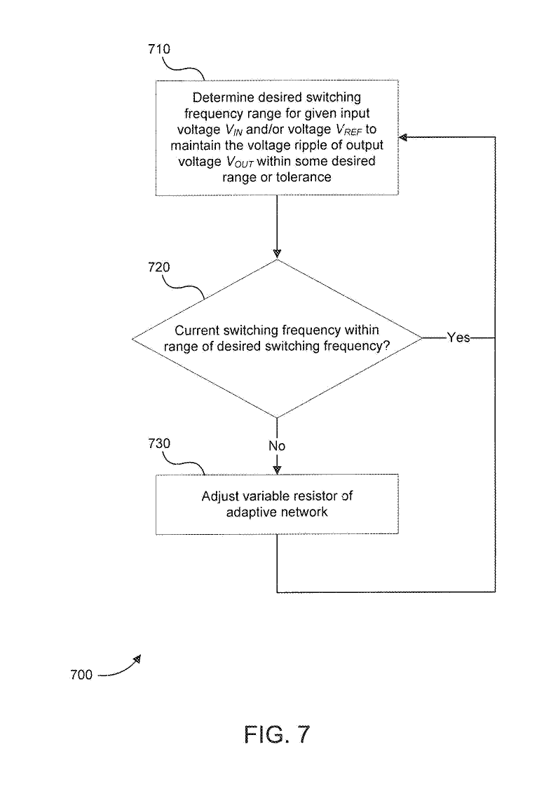

FIG. 7 illustrates an exemplary method 700 for maintaining output ripple voltage in a hysteretic switching regulator within some desired range according to embodiments of the present disclosure. Method 700 is described below with reference to hysteretic switching regulator 600 in FIG. 6. It will be appreciated by one of ordinary skill in the art that method 700 can be applied to other switching regulators without departing from the scope and spirit of the present disclosure.

Method 700 starts at step 710. At step 710, a desired switching frequency range for a given input voltage V_{IN} and/or voltage V_{REF} is determined by detector and controller 610 to maintain the ripple voltage of output voltage V_{OUT} within some desired range. After step 710, method 700 transitions to step 720.

At step 720, the current switching frequency of the hysteretic switching regulator is compared to the desired switching frequency range. If the current switching frequency of the hysteretic switching regulator is within the desired switching frequency range, method 700 proceeds back to step 710 and method 700 is repeated. In one embodiment, method 700 is repeated after a set delay or after a pre-determined period of time has expired. If, on the other hand, the current switching frequency of the hysteretic switching regulator is not within the desired switching frequency range, method 700 proceeds to step 730.

At step 730, a circuit parameter k of hysteretic switching regulator 600 that controls the slope (or ramp rate) of the feedback signal V_{RAMP} is adjusted to maintain the switching frequency within the desired switching frequency range. Detector and controller 610 adjusts the resistance of variable resistor 630 to maintain the switching frequency within the desired switching frequency range as described above. In this embodiment, the circuit parameter k of hysteretic switching regulator 600 corresponds to the resistance parameter of variable resistor 630 and is related to the rate at which the feedback signal V_{RAMP} changes for a given voltage across variable resistor 630. After step 730 completes, method 700 transitions back to step 710 and method 700 is repeated. In one embodiment, method 700 is repeated after a set delay or after a pre-determined period of time has expired.

### 3. CONCLUSION

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A hysteretic switching regulator, comprising:
a power switch configured to couple and decouple an unregulated input voltage to a first end of an inductor based on a comparator signal to provide a regulated output voltage at a second end of the inductor;
a sensing network configured to provide a ramp signal;
a hysteretic comparator configured to compare the ramp signal with a reference voltage to provide the comparator signal; and
a detector and controller configured to adjust a parameter of the hysteretic switching regulator to maintain a ripple voltage of the regulated output voltage within a ripple voltage range.

2. The hysteretic switching regulator of claim 1, wherein the detector and controller is configured to adjust the parameter based on a change in the unregulated input voltage or a change in the reference voltage.

3. The hysteretic switching regulator of claim 1, wherein the detector and controller is configured to adjust the parameter based on a change in a frequency at which the power switch module couples and decouples the unregulated input voltage to the first end of the inductor.

4. The hysteretic switching regulator of claim 1, wherein the detector and controller is configured to adjust the parameter based on the ripple voltage of the regulated output voltage.

5. The hysteretic switching regulator of claim 1, wherein the sensing network comprises an integrator formed at least in part by a series coupled resistor and capacitor.

6. The hysteretic switching regulator of claim 5, wherein the parameter is a resistance associated with the resistor of the sensing network or a capacitance associated with the capacitor.

7. The hysteretic switching regulator of claim 1, further comprising:
an adaptive network formed at least in part by a parallel coupled resistor/inductor pair, the adaptive network coupled to the second end of the inductor to adjust a slope of the ramp signal through the sensing network.

8. The hysteretic switching regulator of claim 7, wherein the parameter is a resistance associated with the parallel coupled resistor/inductor pair.

9. A hysteretic switching regulator, comprising:
a power switch configured to couple and decouple an unregulated input voltage to a first end of an inductor based on a comparator signal to provide a regulated output voltage at a second end of the inductor:
an integrator configured to integrate a voltage across the inductor to provide a ramp signal;
a hysteretic comparator configured to compare the ramp signal with a reference signal to provide the comparator signal; and
a detector and controller configured to:
determine a switching frequency range for maintaining a ripple voltage on the regulated output voltage within a ripple voltage range, and
adjust a parameter of the hysteretic switching regulator to maintain a frequency at which the power switch module couples and decouples the unregulated input voltage to the first end of the inductor within the switching frequency range.

10. The hysteretic switching regulator of claim 9, wherein the detector and controller is configured to determine the switching frequency range based on the unregulated input voltage.

11. The hysteretic switching regulator of claim 9, wherein the detector and controller is configured to determine the switching frequency range based on the reference signal.

12. The hysteretic switching regulator of claim 9, wherein the integrator includes a series coupled resistor and capacitor.

13. The hysteretic switching regulator of claim 12, wherein the parameter of the hysteretic switching regulator is a resistance associated with the resistor or a capacitance associated with the capacitor.

14. The hysteretic switching regulator of claim 9, wherein the detector and controller is configured to monitor the comparator signal to determine the frequency at which the power switch module couples and decouples the unregulated input voltage to the first end of the inductor.

15. The hysteretic switching regulator of claim 9, further comprising:
an adaptive network formed at least in part by a parallel coupled resistor/inductor pair, the adaptive network coupled to the second end of the inductor, wherein the parameter is a resistance associated with the parallel coupled resistor/inductor pair.

16. A method for operating a hysteretic switching regulator, comprising:
coupling and decoupling an unregulated input voltage to a first end of an inductor based on a comparator signal to provide a regulated output voltage at a second end of the inductor;
integrating a voltage across the inductor, using an integrator, to provide a ramp signal;
comparing the ramp signal with a reference signal to provide the comparator signal;
determining a switching frequency range for maintaining a ripple voltage on the regulated output voltage within a ripple voltage range; and
adjusting a parameter of the hysteretic switching regulator to maintain a frequency at which the unregulated input voltage is coupled and decoupled to the first end of the inductor within the switching frequency range.

17. The method of claim 16, wherein determining the switching frequency range comprises:
determining the switching frequency range to maintain the ripple voltage on the regulated output voltage within the ripple voltage range based on the unregulated input voltage.

18. The method of claim 16, wherein determining the switching frequency range comprises:
determining the switching frequency range to maintain the ripple voltage on the regulated output voltage within the ripple voltage range based on the reference signal.

19. The method of claim 16, wherein:
the integrator includes a series coupled resistor and capacitor, and
the parameter of the hysteretic switching regulator is a resistance associated with a resistor or a capacitance associated with the capacitor.

20. The method of claim 16, wherein the parameter of the hysteretic switching regulator is a resistance associated with an adaptive network formed at least in part by a parallel coupled resistor/inductor pair, the adaptive network coupled to the second end of the inductor.
